(19) United States
(12) Patent Application Publication
(10) Pub. No.: US 2007/0174995 A1
(43) Pub. Date: Aug. 2, 2007

(54) ELECTRONIC DEVICE

(75) Inventor: Wen-Ting Yu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/625,347

(22) Filed: Jan. 22, 2007

(30) Foreign Application Priority Data
Jan. 27, 2006 (TW) 95103388

(51) Int. Cl. E05F 3/22

(52) U.S. Cl. 16/54

(57) ABSTRACT

An electronic device having a first body, a second body and a hinge is provided. The first body and the second body are pivoted through the hinge. The hinge includes a sleeve, at least one first positioning member, a shaft and a second positioning member. The first positioning member is inserted into the sleeve. A first end of the shaft passes through the sleeve. The second positioning member is inserted into the shaft. The second positioning member and the first positioning member are linked through magnetic force to fix the position of the shaft.

### CROSS-REFERENCE TO RELATED APPLICATION

This application claims the priority benefit of Taiwan application serial no. 95103388, filed Jan. 27, 2006. All disclosure of the Taiwan application is incorporated herein by reference.

### BACKGROUND OF THE INVENTION

1. Field of the Invention

The present invention relates to an electronic device. More particularly, the present invention relates to an electronic device having a hinge regulated by a magnetic force.

2. Description of the Related Art

In recent years, the flip top mobile phone has gradually become a standard in the cellular phone market. With the constant innovation in the style and design of mobile phone, manufacturers have produced lighter, slimmer and more stylist models with increasing number of functions. Aside from the basic conversational function, other accessory functions including special ring tone, games, mobile secretary and mobile Internet services are also introduced.

FIG. 1A is a cutaway view of a hinge used in a conventional flip top mobile phone. FIG. 1B is an explosion view showing various components inside the hinge of a conventional flip top mobile phone. As shown in FIGS. 1A and 1B, the hinge 130 pivots the cover flap 120 to the main body 110. The hinge 130 includes a first member 1310, a second member 1320, a spring 1330, a stopper 1340 and a shaft 1350. The first member 1310 has a first end 1310a inserted into the main body 110. The second member 1320 has a first end 1320a inserted into a second end 1310b of the first member 1310. The shaft 1350 passes through the stopper 1340, the spring 1330 and the second member 1320 in sequence and the spring 1330 forces the second member 1320 toward the first member 1310. Due to the geometry relation between the second member 1320 and the first member 1310, the second member 1320 has only two states relative to the first member, namely, a 0° angle and a 180° angle when the hinge 130 is applied to a conventional flip top mobile phone.

However, to prevent the angle between the cover and the main body from spreading too far, a position-limiting structure (not shown) is often designed and installed on the main body. Moreover, after flipping the cover open and close with respect to the main body a number of times, some of the paint on the main body may fall off. In addition, the conventional flip top mobile phone will be increasingly difficult to design if the flip cover needs to be set at a particular angle relative to the main body. Furthermore, the connection between the main body and the flip top may loosen after a while.

### SUMMARY OF THE INVENTION

Accordingly, at least one objective of the present invention is to provide an electronic device having a design capable of minimizing the peeling of paint as a result of flipping a cover of the electronic device repeatedly.

At least a second objective of the present invention is to provide an electronic device having a design capable of preventing the loosening of the connection between two main bodies of the electronic device.

To achieve these and other advantages and in accordance with the purpose of the invention, as embodied and broadly described herein, the invention provides an electronic device. The electronic device includes a first body, a second body and a hinge. The first body and the second body are pivoted through the hinge. The hinge includes a sleeve, at least one first positioning member, a shaft and a second positioning member. The first positioning member is inserted into the sleeve. A first end of the shaft passes through the sleeve. The second positioning member is inserted into the shaft. The second positioning member and the first positioning member are linked through magnetic force to fix the position of the shaft.

In one embodiment of the present invention, either the first positioning member or the second positioning member is a magnet while the other is either a magnet or an object fabricated using a magnetic material.

In one embodiment of the present invention, the hinge further includes a spring disposed inside the sleeve and inserted into a second end of the shaft.

In one embodiment of the present invention, the hinge further includes a third positioning member and a fourth positioning member. The third positioning member is disposed inside the sleeve and inserted into the spring. Furthermore, a first end of the third positioning member is fixed inside the second end of the shaft. The fourth positioning member is disposed inside the sleeve. Moreover, a second end of the third positioning member and the fourth positioning member can interact through frictional force produced by a magnetic to fix the position of the shaft.

In one embodiment of the present invention, either the third positioning member or the fourth positioning member is a magnet while the other is either a magnet or an object fabricated using a magnetic material.

In one embodiment of the present invention, the third positioning member and the shaft are formed as an integrative unit.

In one embodiment of the present invention, the third positioning member, the second positioning member and the shaft are formed as an integrative unit.

In one embodiment of the present invention, the second positioning member and the shaft are formed as an integrative unit.

In one embodiment of the present invention, the first positioning member and the sleeve are formed as an integrative unit.

The present invention also provides an alternative electronic device. The electronic device includes a first body, a second body and a hinge. The first body and the second body are pivoted through the hinge. The hinge includes a sleeve, a shaft, a third positioning member and a fourth positioning member. A first end of the shaft passes through the sleeve. The third positioning member is disposed inside the sleeve. Furthermore, a first end of the third positioning member is inserted into a second end of the shaft. The fourth positioning member is disposed inside the sleeve. Moreover, a second end of the third positioning member and the fourth positioning member can interact through frictional force produced by a magnetic to fix the position of the shaft.

In one embodiment of the present invention, the hinge further includes a spring disposed inside the sleeve and inserted into the second end of the shaft. Moreover, the third positioning member is inserted into the spring.

In one embodiment of the present invention, either the third positioning member or the fourth positioning member is a magnet while the other is a magnet or an object fabricated using a magnetic material.

In one embodiment of the present invention, the third positioning member and the shaft are formed as an integrative unit.

Accordingly, the present invention utilizes magnetic force as the mechanism for fixing the position of the hinge. Thus, compared with the conventional technique, the present invention not only can provide a specific angle positioning function (for fully opening or closing the cover of an electronic device), but also provides positioning at whatever intermediate angle.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a cutaway view of a hinge used in a conventional flip top mobile phone.

FIG. 1B is an explosion view showing various components inside the hinge of a conventional flip top mobile phone.

FIG. 2A is a perspective view of an electronic device according to one embodiment of the present invention.

FIG. 2B is a perspective view of the hinge in the electronic device shown in FIG. 2A.

FIG. 2C is a cross-sectional view of the hinge in the electronic device shown in FIG. 2A.

FIG. 2D is an explosion view showing various components constituting the hinge in the electronic device shown in FIG. 2A.

FIGS. 3A and 3B are cross-sectional views showing two possible operational configurations of the hinge shown in FIG. 2A.

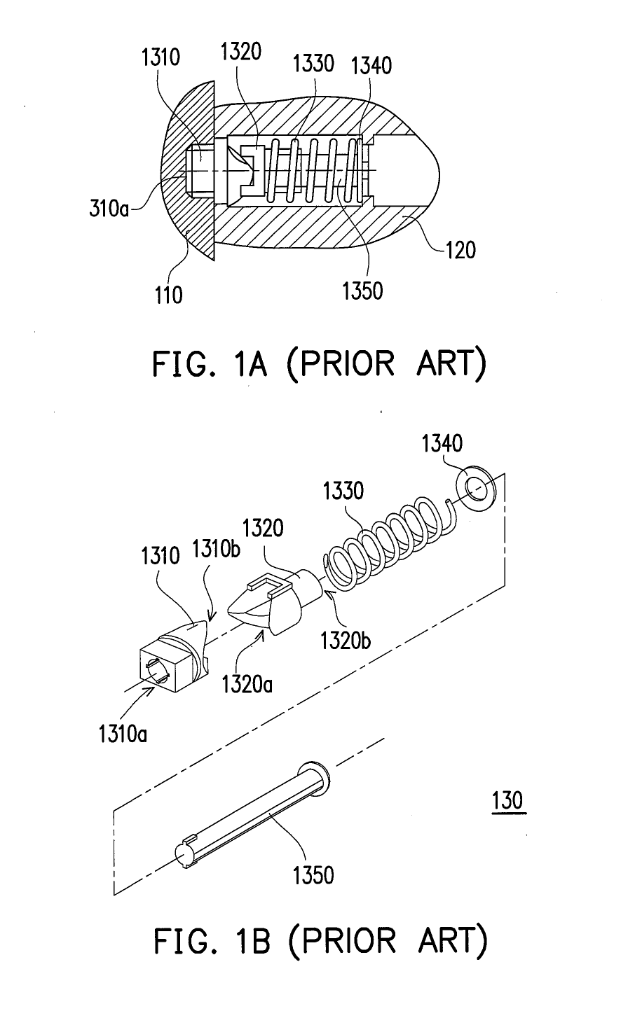

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

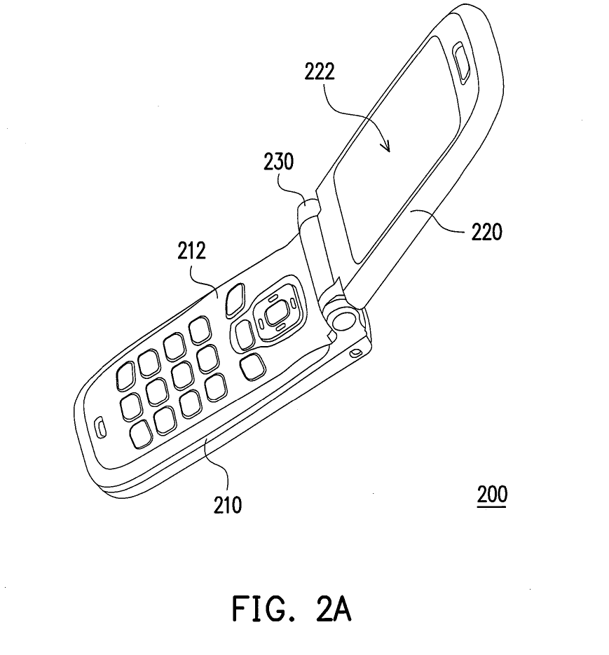

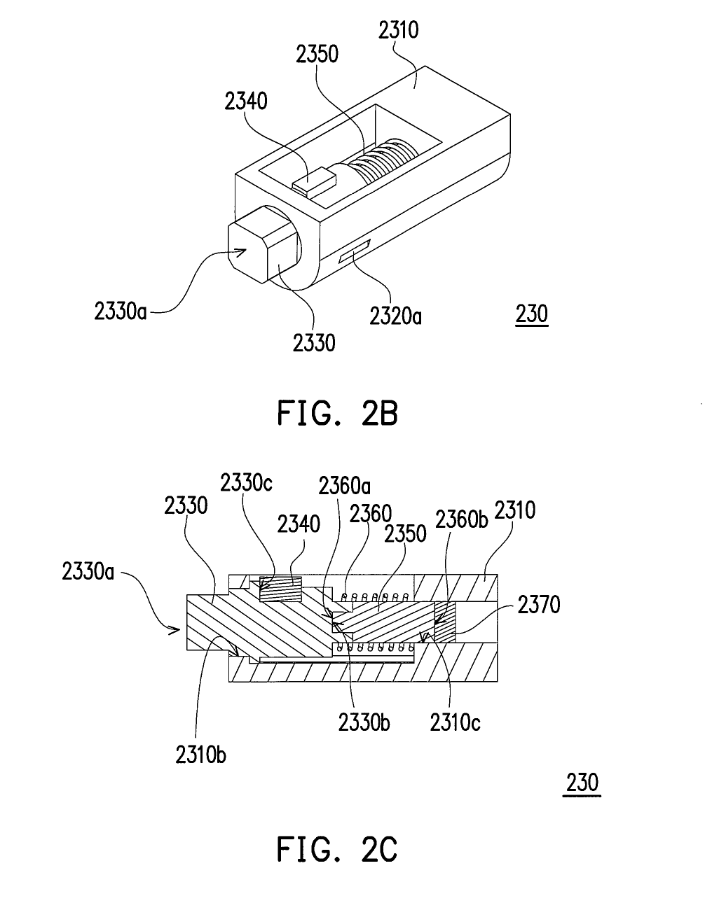

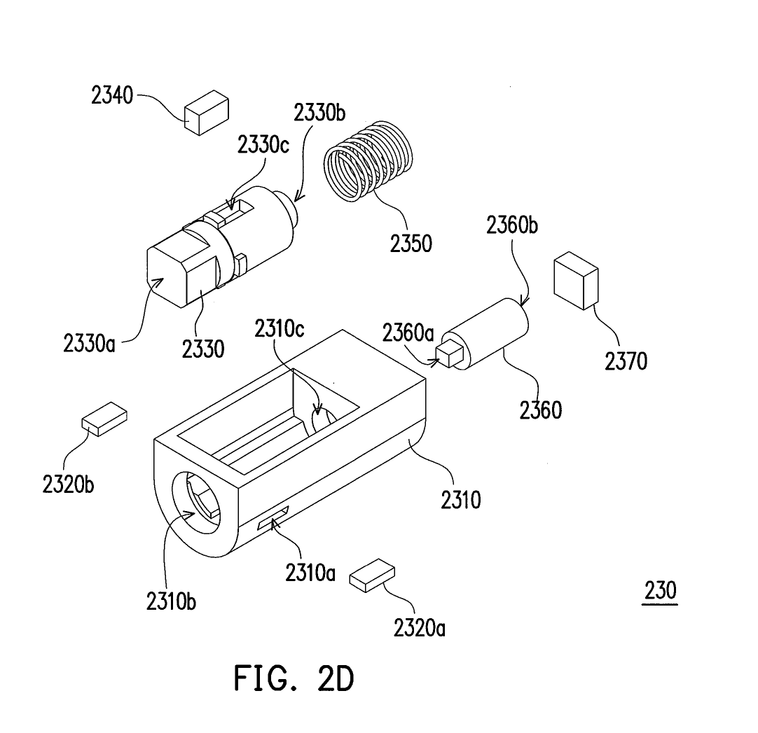

FIG. 2A is a perspective view of an electronic device according to one embodiment of the present invention. As shown in FIG. 2A, the electronic device 100 in the present embodiment includes a first body 210, a second body 220 and a hinge 230. The hinge 230 pivots the first body 210 to the second body 220. In the present embodiment, the electronic device 200 is a mobile phone. However, the electronic device 200 can equally be a notebook computer, a personal digital assistant (PDA) or other electronic device requiring a hinge. If the electronic device 200 is a mobile phone, the first body 210 has a keypad 212 and the second body 220 has a display screen 222. When the user lifts up the second body 220, the display screen 222 can display various functions and operational states. In addition, the user may use the keypad 212 for communicating with others. The fine structure of the hinge 230 is described in the following.

FIG. 2B is a perspective view of the hinge in the electronic device shown in FIG. 2A. FIG. 2C is a cross-sectional view of the hinge in the electronic device shown in FIG. 2A. FIG. 2D is an explosion view showing various components constituting the hinge in the electronic device shown in FIG. 2A. As shown in FIGS. 2B, 2C and 2D, the hinge 230 includes a sleeve 2310, a pair of first positioning members 2320a and 2320b, a shaft 2330, a second positioning member 2340 and a spring 2350. The first positioning members 2320a and 2320b are inserted into the sleeve 2310. For example, the first positioning member 2320a is inserted into an opening 2310a of the sleeve 2310, and the first positioning member 2320b is inserted into another opening (not shown). Alternatively, the sleeve 2310 and the first positioning members 2320a and 2320b are formed as an integrative unit in an insert molding process. Although the present embodiment uses two first positioning members 2320a and 2320b, a single first positioning member 2320a can also be used.

The shaft 2330 is disposed inside the sleeve 2310. Furthermore, a first end 2330a of the shaft 2330 passes through an opening 2310b of the sleeve 2310. In other words, due to the constraints of the openings 2310 and 2310c, the shaft 2330 is free to rotate only in the axial direction and move in the axial direction. The first end 2330a of the shaft 2330 can be a cornered block to facilitate its insertion into the first body 210. On the other hand, the second positioning member 2340 is inserted into the shaft 2330. For example, the second positioning member 2340 is inserted into a groove 2330c on the shaft 2330. Alternatively, the second positioning member 2340 and the shaft 2330 are formed as an integrative unit in an insert molding process. The spring 2350 is disposed inside the sleeve 2310 and inserted a second end 2330b of the shaft 2330.

It should be noted that the second positioning member 2340 is a magnet, and the first positioning members 2320a and 2320b are fabricated using a magnetic material. The magnetic material includes iron or other materials that are attracted to a magnet. In other words, the first positioning members 2320a or 2320b and the second positioning member 2340 are linked through a magnetic force so that the position of the shaft 2330 can be fixed.

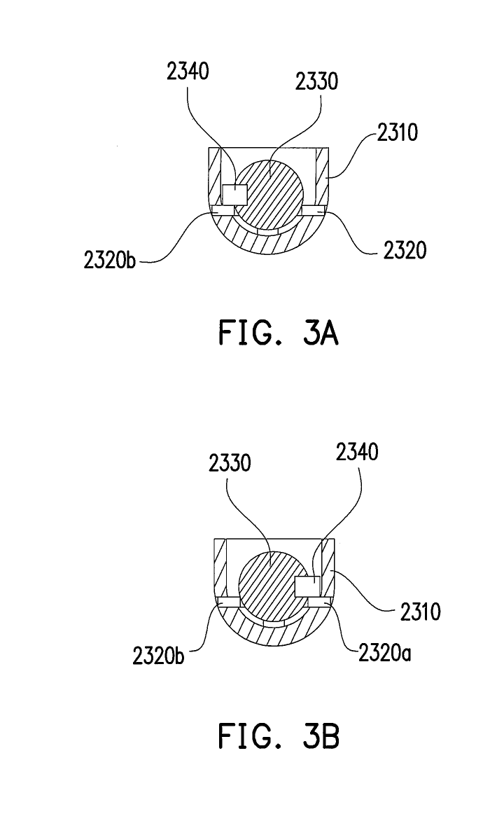

FIGS. 3A and 3B are cross-sectional views showing two possible operational configurations of the hinge shown in FIG. 2A. As shown in FIGS. 2A and 3A, the second positioning member 2340 and the first positioning member 2320b are in contact because of the magnetic force when the user spreads out the electronic device 200. Hence, the angular displacement of the shaft 2330 is also fixed. In other words, the first body 210 and the second body 220 are maintained in an open configuration with respect to each other.

Similarly, as shown in FIGS. 2A and 3B, the second positioning member 2340 and the first positioning member 2320a are in contact because of the magnetic force when the user retracts the electronic device 200. Hence, the angular displacement of the shaft 2330 is also fixed. In other words, the first body 210 and the second body 220 are maintained in a folded configuration with respect to each other. It should be noted that the angular spread between the first body 210 and the second body 220 could be different according to the setting position of the first positioning members 2320a and 2320b. Simply, if the location of the first positioning members 2320a and 2320b are a little higher than the one shown in FIG. 3A and FIG. 3B, the angular spread between the first body 210 and the second body 220 when the electronic device 200 is opened will be reduced.

Unlike the conventional hinge that uses a mechanical force to control the angular displacement of the hinge, a magnetic force is used as the principle positioning mechanism in the hinge 230 of the embodiment of the present invention. Since the spring 230 is not used as a member for controlling the angular displacement, a lesser spring force is demanded from the spring 230.

In the present embodiment, the second positioning member 2340 is a magnet while the first positioning members 2320a and 2320b are fabricated using magnetic material. However, in another embodiment, the first positioning members 2320a and 2320b can be magnets while the second positioning member 2340 can be fabricated using magnetic material. To increase the magnetic attraction, both the second positioning member 2340 and the first positioning members 2320a and 2320b can be magnets. Furthermore, when the second positioning member 2340 or the first positioning members 2320a and 2320b are magnets, the respective second positioning member 2340 or first positioning members 2320a, 2320b can be individually magnetized after the assembling process is completed. Moreover, the sleeve 2310 and the shaft 2330 can be fabricated using a non-magnetic material, for example, a non-magnetic metal or plastic instead of a magnetic material.

As shown in FIGS. 2C and 2D, the second positioning member 2340 and the first positioning members 2320a and 2320b together can provide the hinge 230 the capacity for setting at two different angles. However, the hinge 230 can provide free stops at whatever angle too. More specifically, if the hinge 230 is free to stop at any angle, the hinge 230 further includes a third positioning member 2360 and a fourth positioning member 2370. The third positioning member 2360 is disposed inside the sleeve 2310 and inserted into the spring 2350. In addition, a first end 2360a of the third positioning member 2360 flushes into the second end 2330b of the shaft 2330. For example, the third positioning member 2360 is a cylindrical body and the first end 2360a of the third positioning member 2360 is a cornered block. In other words, the shaft 2330 and the third positioning member 2360 can rotate simultaneously. Alternatively, the shaft 2330 and the third positioning member 2360 are formed as an integrative unit in an insert molding operation. In addition, the second positioning member 2340, the shaft 2330 and the third positioning member 2360 can be fabricated as an integrative unit in an insert molding process.

The fourth positioning member 2370 is also disposed inside the sleeve 2310. In the present embodiment, the fourth positioning member 2370 is a magnet and the third positioning member 2360 is fabricated using a magnetic material. Hence, a first end 2360b of the third positioning member 2360 is adapted to be in contact with the fourth positioning member 2370 through a magnetic force. In other words, a frictional force between the third positioning member 2360 and the fourth positioning member 2370 is achieved through a magnetic force so that the shaft 2330 can be set at whatever angle as desired. Furthermore, to prevent the third positioning member 2360 from driving the fourth positioning member 2370, the fourth positioning member 2370 is preferably a cubic body fixed inside the sleeve 2310.

The fourth positioning member 2370 is a magnet while the third positioning member 2360 is fabricated using a magnetic material. However, in another embodiment, the third positioning member 2360 can be a magnet while the fourth positioning member 2370 is fabricated using a magnetic material. Alternatively, to increase the friction provided by the magnetic force, both the third positioning member 2360 and the fourth positioning member 2370 can be magnets.

It should be noted that special angular positioning function provided by the second positioning member 2340 and the first positioning members 2320a, 2320b and the free angular stop provided by the third positioning member 2360 and the fourth positioning member 2370 can be independently or jointly used. Moreover, the hinge 230 can also be applied to other structures beside the electronic device 200.

In summary, the electronic device according to the embodiment of the present invention has at least the following advantages:

1. Due to the mutual magnetic attraction between the first positioning member and the second positioning member, the hinge having the first positioning member and the second positioning member can provide a specific angle setting function.

2. Due to the friction provided by the magnetic force between the third positioning member and the fourth positioning member, the hinge having the third positioning member and the fourth positioning member can provide a free angular stopping function.

3. Compared with the conventional hinge that uses a spring to provide a mechanical force, the present invention uses a spring with lesser spring force. Moreover, some of the components in the hinge can be made of plastic so that the embodiment of the present invention is more cost effective in production.

It will be apparent to those skilled in the art that various modifications and variations can be made to the structure of the embodiment of the present invention without departing from the scope or spirit of the invention. In view of the foregoing, it is intended that the embodiment of the present invention cover modifications and variations of this invention provided they fall within the scope of the following claims and their equivalents.

What is claimed is:

1. An electronic device, comprising:
a first body;
a second body pivoted to the first body;
a hinge for pivoting the second body to the first body; having:
a sleeve;
at least a first positioning member inserted into the sleeve;
a shaft having a first end passing through the sleeve; and
a second positioning member inserted into the shaft, wherein the first positioning member and the second positioning member are joined together through a magnetic force so that the position of the shaft is fixed.

2. The electronic device of claim 1, wherein either the first positioning member or the second positioning member is a magnet while the other is a magnet or an object fabricated using a magnetic material.

3. The electronic device of claim 1, wherein the hinge further includes a spring disposed inside the sleeve and inserted into the shaft.

4. The electronic device of claim 3, wherein the hinge further includes:
a third positioning member disposed inside the sleeve and inserted into the spring, wherein a first end of the third positioning member is inserted into the second end of the shaft; and
a fourth positioning member disposed inside the sleeve, wherein a second end of the third positioning member and the fourth positioning member are adapted to fixing the position of the shaft through a magnetic force.

5. The electronic device of claim 4, wherein either the third positioning member or the fourth positioning member is a magnet while the other is a magnet or an object fabricated using a magnetic material.

6. The electronic device of claim 4, wherein the third positioning member and the shaft are formed together as an integrative unit.

7. The electronic device of claim 4, wherein the third positioning member, the second positioning member and the shaft are formed together as an integrative unit.

8. The electronic device of claim 1, wherein the second positioning member and the shaft are formed together as an integrative unit.

9. The electronic device of claim 1, wherein the first positioning member and the sleeve are formed together as an integrative unit.

10. An electronic device, comprising:
a first body;
a second body pivoted to the first body;
a hinge for pivoting the second body to the first body, having:
a sleeve;
a shaft having a first end passing through the sleeve;
a third positioning member disposed inside the sleeve such that a first end of the third positioning member is inserted into a second end of the shaft; and
a fourth positioning member disposed inside the sleeve such that a second end of the third positioning member and the fourth positioning member fix the position of the shaft through a magnetic force.

11. The electronic device of claim 10, wherein the hinge further includes a spring disposed inside the sleeve and inserted into a second end of the shaft, and furthermore, the third positioning member is inserted into the spring.

12. The electronic device of claim 10, wherein either the third positioning member or the fourth positioning member is a magnet while the other is a magnet or an object fabricated using a magnetic material.

13. The electronic device of claim 10, wherein the third positioning member and the shaft are formed together as an integrative unit.
